(19) United States
(12) Patent Application Publication
(10) Pub. No.: US 2016/0017107 A1
(43) Pub. Date: Jan. 21, 2016

(54) Method of Fabricating Foam Container

(71) Applicant: Pei-Ti Lin, Taipei (TW)

(72) Inventor: Pei-Ti Lin, Taipei (TW)

(21) Appl. No.: 14/740,459

(22) Filed: Jun. 16, 2015

(30) Foreign Application Priority Data
Jul. 18, 2014 (TW) 103124863

(51) Int. Cl. C08J 9/00

(52) U.S. Cl. CPC C08J 9/0004; C08J 9/0061; C08J 2375/04; C08J 2400/12

(57) ABSTRACT

A foam container is made. A foam material is uniformly coated on at least one surface of the container. The foam material is formed by mixing a PU aqueous liquid, a defoamer, a thickener, a foaming agent, an adhesive and an additive. Fabrication speed is improved with reduced power consumption. The container thus fabricated has increased thickness, good hydrolysis resistance, good adhesion (without crumbs dropped), good heat insulation, good scratch resistance, good abrasion resistance, good printability and good workability for continuous production.

### TECHNICAL FIELD OF THE INVENTION

The present invention relates to fabricating a foam container; more particularly, relates to improving fabrication speed with reduced power consumption while the container fabricated has increased thickness, good hydrolysis resistance, good adhesion (without crumbs dropped), good heat insulation, good scratch resistance, good abrasion resistance, good printability and good workability for continuous production.

### DESCRIPTION OF THE RELATED ART

Generally, on making a foam container, a material of polypropylene (PP), polyethylene (PE), PLA, etc. is used as a foam material to be coated on surface of the container; and, then, the container coated with the foam material is sent to be heated for forming a foam layer on the surface of the container with the material of PP, PE or PLA.

However, although PP, PE or PLA can be used as the foam material, PP, PE or PLA is simply a plastic material that foaming effect is often poor by heating up PP, PE or PLA. Besides, when a heating temperature reaches 120 Celsius degrees (° C.), an inner film of a PE cup may be easily hot-stripped.

Furthermore, when PP, PE or PLA is used as the foam material to be heated, the container and the foam material are heated simultaneously. Yet, in fact, only the foam material needs to be heated. Therefore, because the container and the foam material both absorb heat energy as being heated, not only time and temperature for heating become hard to control; but also more energy is consumed owing to the heat energy absorbed by both of the container and the foam material. Hence, the prior art does not fulfill all users' requests on actual use.

### SUMMARY OF THE INVENTION

The main purpose of the present invention is to improve speed of fabricating a foam container with reduced power consumption while the container thus fabricated has increased thickness, good hydrolysis resistance, good adhesion (without crumbs dropped), good heat insulation, good scratch resistance, good abrasion resistance, good printability and good workability for continuous production.

To achieve the above purpose, the present invention is a method of fabricating a foam container, comprising steps of: (a) taking a container; (b) uniformly coating a foam material on at least one surface of the container, where the foam material is obtained by mixing a PU aqueous liquid, a defoamer, a thickener, a foaming agent, an adhesive and an additive; and (c) heating up the container coated with the foam material to form a foam layer on the at least one surface of the container. Accordingly, a novel method of fabricating a foam container is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is the view showing step (a) of the preferred embodiment according to the present invention;

FIG. 2 is the view showing step (b);

FIG. 3 is the view showing step (c);

FIG. 4 is the view showing the state of the present invention obtained after step (c); and

FIG. 5 is the view showing the states of characteristics of the present invention under the various component proportions.

### DESCRIPTION OF THE PREFERRED EMBODIMENT

The following description of the preferred embodiment is provided to understand the features and the structures of the present invention.

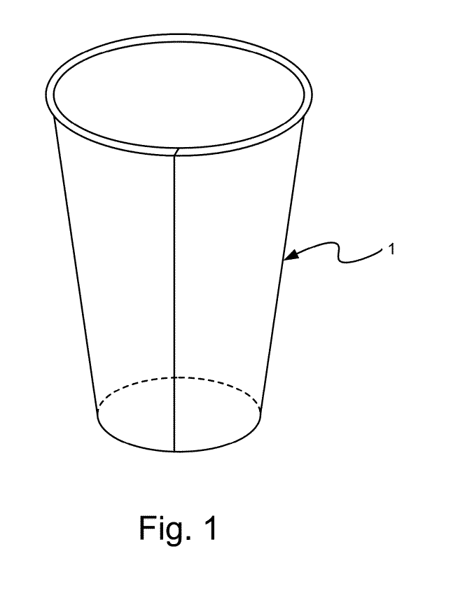

Please refer to FIG. 1 to FIG. 5, which are views showing step (a) to step (c) of a preferred embodiment according to the present invention; a view showing a state of the present invention obtained after step (c); and a view showing states of characteristics of the present invention under various component proportions. As shown in the figures, the present invention is a method of fabricating a foam container, comprising the following steps:

(a) Take a container 1. The container 1 is a paper cup, a paper plate or a paper lunch box (as shown in FIG. 1).

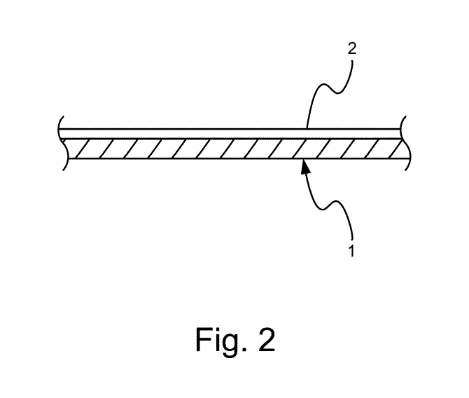

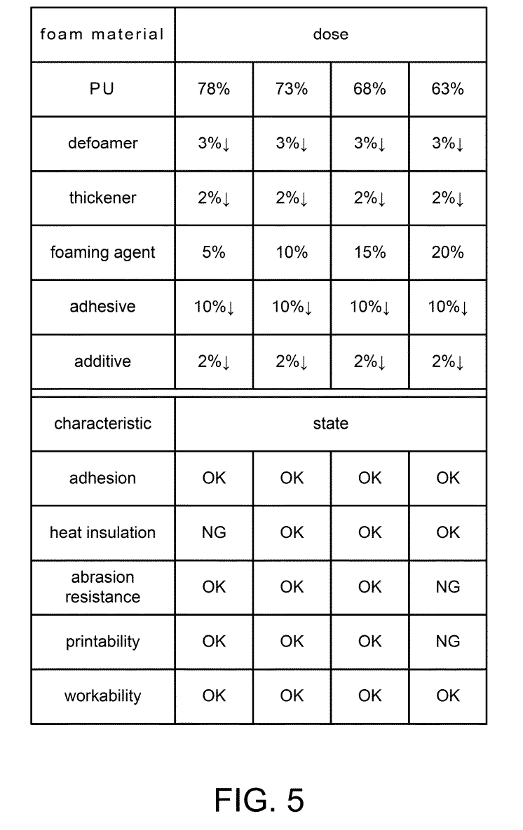

(b) On at least one surface of the container 1, a foam material 2 is uniformly coated through printing. The foam material 2 (as shown in FIG. 5) comprises a PU aqueous liquid having a dose of PU between 63% and 78% and a solid content more than 40%; a defoamer having a dose less than 3%; a thickener having a dose less than 2%; a foaming agent having a dose between 5% and 20%; an adhesive having a dose less than 15%; and an additive having a dose less than 2%. Therein, the defoamer is organic siloxane, polyether, amide or any defoamer compliant with FDA specifications like polydimethyl silicone, Methylated, Silica, Dow Chemieal, unco 50-Hb-5100, unco 50-Hb-3520, unco 50-Hb-2000, etc. The thickener is a food-grade one, such as CMC, Xanthan gun, Sodium Alginate, HEUR, HMPE, etc. The form agent is a food-grade chemical foaming agent, a physical foaming agent (e.g. AKZO Nobel Expancel, Sekisui Advancell, Matsumoto Microsphere, etc.) or a mechanical foaming agent. The adhesive is a food-grade one, such as PVA, PVB, PP, PES, LDPE, HDPE, EMA, EVA, EAA, EMMA, PCL, TPU, PA, etc. The additive is a crosslinking agent or a dispersant. With the above components having their doses and characteristics, the foam material 2 is uniformly coated on the at least one surface of the container 1, as shown in FIG. 2.

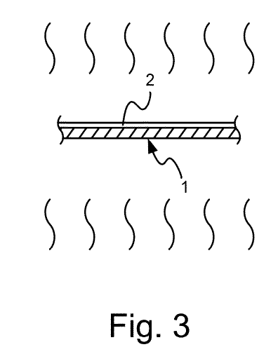

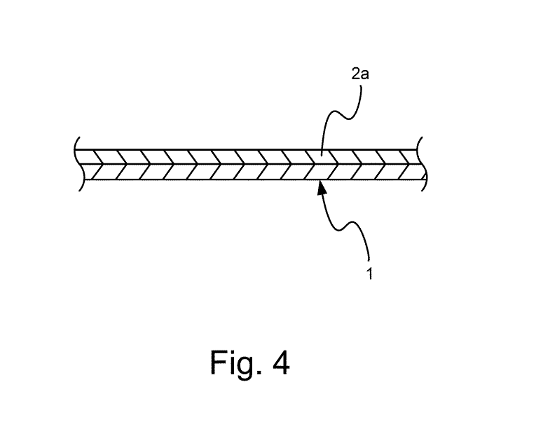

(c) The container 1 coated with the foam material 2 is heated for a time of 180 seconds±15%, as shown in FIG. 3, to reach a temperature of 110 Celsius degrees (° C.) ±20° C. Since the foam material 2 comprises the PU aqueous solution, the defoamer, the thickener, the foam agent, the adhesive and the additive, a plurality of enclosed bubbles can be uniformly generated on the surface of the container 1. Thus, by adhering a food-grade PU material on the surface of the container 1, heat source is not wasted but fabrication speed is further improved with reduced power consumption. Conclusively, a form layer 2a is formed on the surface of the container 1 after heating up the foam material 2, as shown in FIG. 4. After heating up the foam material 2, the form layer 2a is formed to have an at least 6-fold thickness. Consequently, the container 1 has increased thickness, good hydrolysis resistance, good adhesion (without crumbs dropped), good heat insulation, good scratch resistance, good abrasion resistance, good printability and good workability for continuous production, as shown in FIG. 5.

However, the foam layer 2a can be deposed on an inner or outer surface of the container 1, or on both inner and outer surfaces of the container 1 to obtain thermal insulation according to different requirements.

To sum up, the present invention is a method of fabricating a foam container, where fabrication speed is improved with reduced power consumption and a container thus fabricated has increased thickness, good hydrolysis resistance, good adhesion (without crumbs dropped), good heat insulation, good scratch resistance, good abrasion resistance, good printability and good workability for continuous production.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A method of fabricating a foam container, comprising steps of:
(a) obtaining a container;
(b) uniformly coating a foam material on at least one surface of said container, wherein said foam material is obtained by mixing a PU aqueous liquid, a defoamer, a thickener, a foaming agent, an adhesive and an additive; and
(c) heating up said container coated with said foam material to obtain a foam layer on said at least one surface of said container.

2. The method according to claim 1,
wherein said container is selected from a group consist of a paper cup, a paper plate and a paper lunch box.

3. The method according to claim 1,
wherein said PU aqueous liquid has a dose of PU between 63% and 78% and a solid content more than 40%.

4. The method according to claim 1,
wherein said defoamer has a dose less than 3%;

5. The method according to claim 4,
wherein said defoamer is selected from a group consist of organic siloxane, polyether, amide and any defoamer compliant with FDA specifications; and
wherein said defoamer compliant with FDA specifications is selected from a group consist of polydimethyl silicone, Methylated, Silica, Dow Chemieal, unco 50-Hb-5100, unco 50-Hb-3520 and unco 50-Hb-2000.

6. The method according to claim 1,
wherein said thickener has a dose less than 2%.

7. The method according to claim 6,
wherein said thickener is a food-grade thickener selected from a group consist of CMC, Xanthan gun, Sodium Alginate, HEUR and HMPE.

8. The method according to claim 1,
wherein said foaming agent has a dose between 5% and 20%.

9. The method according to claim 8,
wherein said foaming agent is selected from a group consist of a food-grade chemical foaming agent, a physical foaming agent and a mechanical foaming agent.

10. The method according to claim 9,
wherein said food-grade physical foaming agent is selected from a group consist of AKZO Nobel Expancel, Sekisui Advancell and Matsumoto Microsphere.

11. The method according to claim 1,
wherein said adhesive has a dose less than 15%.

12. The method according to claim 11,
wherein said adhesive is a food-grade adhesive selected from a group consist of PVA, PVB, PP, PES, LDPE, HDPE, EMA, EVA, EAA, EMMA, TPU, PCL and PA.

13. The method according to claim 1,
wherein said additive has a dose less than 2%.

14. The method according to claim 13,
wherein said additive is selected from a group consist of a crosslinking agent and a dispersant.

15. The method according to claim 1,
wherein, in step (c), said foam material is heated at a temperature of 110 Celsius degrees (° C.) ±20° C. to obtain said foam layer.

16. The method according to claim 15,
wherein, after heating said foam material, said foam layer has an at least 6-fold thickness.
